(19) United States
(12) Patent Application Publication
(10) Pub. No.: US 2006/0059663 A1
(43) Pub. Date: Mar. 23, 2006

(54) Disposable hygienic door-knob/handle glove and the means for dispensing and disposing of the same

(76) Inventor: Angelo J. D'Ambrosio, Rochester Hills, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 10/946,041

(22) Filed: Sep. 21, 2004

(51) Int. Cl. G05G 1/06

(52) U.S. Cl. 16/441

(57) ABSTRACT

A disposable hygienic doorknob/handle glove or cover/shield is provided to prevent cross-contamination of germs between multiple users of the same doorknob/handle. The glove or cover/shield of the instant invention includes a hollow three-dimensional body formed of an impervious flexible material, such as paper, or fabric/felt material, which compliments the shape of the doorknob or handle with which it is to communicate or be used. The doorknob cover or shield is sized such that it offers a complete barrier between the skin of the palm and fingers of the hand and the surface of the doorknob. In addition to the doorknob cover/shield or glove, there is provided an elongated cylindrical dispenser for containing and dispensing the cover. The instant invention also provides an accompanying wastebasket so that, after using each cover or glove, the same can be disposed of inside the wastebasket preventing cross-contamination of germs or bacteria.

### CROSS REFERENCE TO RELATED APPLICATION

Not Applicable

### FEDERALLY SPONSORED REASERCH OR DEVELOPMENT

Not Applicable

### REFERENCE TO MICROFICHE APPENDIX

Not Applicable

### BACKGROUND OF THE INVENTION

1. Field of the Invention

The present invention relates generally to hygienic covers or shields and, more particularly, to disposable door-knob/handle gloves or shields useful for protecting one's hand from unsanitary and unsterile conditions.

2. Description of the Related Art

In today's society, people have become more aware and educated about the need to maintain sanitary and sterile conditions of various publicly available facilities as well as some areas of the home. Germs that are present on certain surfaces, such as doorknobs, are becoming more and more susceptible to spreading from one user to another. Public access areas as well as private areas such as bathrooms, hospital rooms, doctors' exam rooms, and kitchens typically have an abundance of unwanted germs present. Washing one's hands is a good defense against unsanitary and unsterile conditions, but does not protect the hands from germs when subsequently opening a door, etc.

Related art reveals that, at one time or another many devices have been offered to protect hands and fingers by employing sprays of disinfectant substances which people can use, as well as to employ paper towel or the like. Although, such devices or means have enjoyed a certain degree of success, nonetheless, the bulk of those inventions, due to lack of ease in employing such solution, and the failure to insure against cross-contamination, have failed as their predecessors did. It is, therefore, desirable to have available a simple, inexpensive, easy to use a device or means for protecting one's hand or hands from germs which may exist in unsanitary or unsterile conditions when contacting surfaces such as doors and door-knobs during normal living conditions. Hence, an attempt is made to address and solve the aforesaid problems with an easy to use, inexpensive, simple disposable sanitary doorknob/handle shield or glove, which is easy to dispense, use, and safely discard into its own wastebasket.

The use of a disinfectant door-knob/handle shields or covers to protect hands is well documented. The purpose of such related art devices vary from multiple uses including painting, illuminating during nighttime or darkness application, decorative applications, as well as sanitary aspects. A more detail description of each of such references will now be made as follows.

U.S. Pat. No. 4,856,140, issued to Visco et al., discloses a sanitary handle cover for either a doorknob or toilet handle. The cover is disclosed as including a cup-like portion defining a pocket for insertingly receiving the knob or handle in close frictional engagement. A constricted neck portion extends or projects from the pocket to cover the mounting shaft of the knob or handle and, if desired, a band retainer is employed for holding the cover in place. A plurality of slits or openings are provided through the material, permitting the user's fingers to grab limited surface areas of the knob or handle allowing knob turning. Visco further discloses employing a disinfectant in its porous material and which is specifically adapted to be slidably engaged over the knob or handle in order to act as a barrier between the fingers of a person and the possible contaminated surface of the knob or handle.

While professing a degree of effectiveness in combating germs and other types of bacteria, Visco appears relatively limited multiple use of the same doorknob cover, whereby the possibility of cross-contamination exists. The material used in the cover is further disclosed as being composed of a porous craft paper or other suitable sheet material which would further seem to compromise the integrity of the device in sealing germs away from contact with the user's hand.

Furthermore, the provision of slits in the cover design, to enable the user to grip the surface of the door handle at certain locations, would seem to largely overcome its professed objective of providing sanitary protection to the user. Along these lines, the argument in favor of the slits in Visco avers that sliding contact of the exposed portions defining the boundaries of the slits, and which are impregnated with disinfectant substance, would act to continually re-sanitize the exposed portions. The truth is that the disinfectant portion would tend to wear or evaporate over any significant period of time and is a poor second to hermetically sealing of the handle or knob from user's contact with the hands.

U.S. Pat. No. 4,921,028, issued to Schwartz, teaches a cover for door hardware which has a plastic sheet adhesively attached to the base of the door hardware and to cover the door hardware while painting. Rather than utilizing an elastic band, as taught in Visco, a side adhesive strip attaches the paint covering to the door handle. U.S. Pat. No. 5,840,122, issued to Williams, teaches another type of doorknob cover for enclosing a knob during painting and includes a particularly escutcheon shaped and spherical resilient knob cover assembly for positioning over the doorknob.

U.S. Pat. No. 5,713,615, issued to Tsai, teaches a stretchable door-knob cover constructed of a soft cloth-like material, shaped similar to a door-knob and including a spherical head, narrower neck and wider base. Openings along the neck of the cover and the flexibility of the material allow the base and neck of the cover to stretch and fit over a doorknob. A string is laced through the neck of the doorknob cover and tied tightly to secure the cover on the doorknob and so that it cannot be removed by pulling. The underside of the cover is coated with a layer of rubber-like material that promotes friction against the surface of the doorknob and to allow easy operation of the knob without the cover slipping. The basis of the device is to provide both decorative and anti-shock aspects and, due to its cloth construction, would not provide any significant degree of sanitary protection.

Finally, the reference U.S. Pat. No. 6,546,594 to Willis, discloses a covering device for use with a door handle and interconnecting shaft extending from a hingedly secured door. The device includes an elasticized body having a substantially three-dimensional shape with an inner face, an outer face, and an open inserting end defined around a narrowed neck of the body. The body further includes a flexible and plasticized material, which may be covered by a soft fabric outer layer. A resilient retaining portion, such as an elasticized ring is disposed around the neck in association with the open inserting end to secure the body in place over the door handle and shaft. Frictional engagement is provided between the inner face of the elasticized body and the door handle surface in use and is preferably provided as an adhesive tacking surface which may be incorporated into an inner ply of the covering device or by way of an applied spray. A portable and carryable dispenser holds, in compressed fashion, a plurality of individual and elasticized bodies provides for the selective dispensing of individual one of the bodies.

The aforementioned prior art devices, attempt to provide protection in the form of a means to cover or shield a door-knob/handle such that, in handling the same, hands and fingers do not come into direct contact with germs and bacteria, which reside on exposed surfaces of such doorknobs and handles. Though the search is not exhaustive, attempts to solve the instant problem have not been successful for the reason articulated above. As described above, in all references, although the devices achieved some degree of success in covering exposed surfaces of a doorknob/handle, all references suffered from the same drawback that, those covers either are not disposable, expensive or not easy to use and dispose of to prevent against cross-contamination.

Consequently, what is needed is a device or means to cover germ-ladened exposed surfaces of a doorknob or handle, which is inexpensive, can be used with most existing doorknobs and handles, first to effectively protect a user from being in contact with such unsanitary or unsterile surface, and subsequently easily disposed of in an accompanying waste basket so that further cross-contamination is virtually eliminated. In addition, it is also desirable that, the disposable shields or covers are stacked in an elongated cylindrical dispenser, or in a coffee-filter like box having a dispensing slit on its top face, which is accompanied with an adjacent waste basket in which to dispose of each used cover or shield.

### BRIEF SUMMARY OF INVENTION

In accordance with the instant invention, there is provided a disposable hygienic door-knob/handle glove or shield, along with a dispenser to dispense the same; and a wastebasket to dispose of each used shield or glove to prevent cross-contamination of germs between multiple users of the doorknob/handle. The glove or shield of the instant invention includes a hollow three-dimensional body formed of an impervious flexible material, such as paper, or fabric/felt material, which is shaped like a coffee filter that would correspond with the shape of the doorknob or handle with which it is to communicate or be used. The doorknob cover or shield is sized such that when in use, it would substantially cover the doorknob, and a portion of the shaft of the knob, and offer a complete barrier between the skin of the palm and fingers of the hand and the surface of the doorknob, so that no unsanitary or unsterile matter or foreign material would come in contact with the exposed surface of the hand. In addition to the doorknob cover or glove, there is provided an elongated cylindrical dispenser/container inside which individual covers are stacked. The dispenser or container may also be a coffee-filter like box, which includes a dispensing slit on its top, bottom or side surface, depending upon the orientation of the placement of the container. The instant invention also provides an accompanying wastebasket so that, after using each cover or glove, the same can be disposed of inside the basket preventing cross-contamination of germs or bacteria. Although, the doorknob cover of the instant invention is intended to be used to protect one's hand from being in contact with germs and foreign material, nonetheless, the same cover can be used for many other applications, namely, the covering of a door-knob while painting a door, or while transporting a pre-manufactured door with all its hardware attached to it.

Accordingly, it is an object of the instant invention to offer a doorknob/handle cover to protect one's hand from coming in contact with an exposed surface of a doorknob or a handle.

Another object of the instant invention, therefore, to provide a doorknob/handle cover or shield for protecting one's hand from germs.

It is yet another object of the present invention to offer a disposable doorknob cover or shield such that, each cover or shield can be disposed of after each use of the same.

A further object of the instant invention is to provide for the disposal of the cover or shield so that, cross-contamination of germs on foreign objects can be prevented.

It is yet another object of the instant invention to provide for easy dispensing of the doorknob covers so that, they can be stacked together for continuous supply between consecutive replenishing of the dispenser.

It is a further object of the instant invention to provide such dispenser with an accompanying waste basket so that, each used door-knob cover or shield can be disposed of so as to prevent transferring the germs from one person to another.

Another object being sought by the present invention is a disposable cover for protecting one's hand from germs, which is simple, inexpensive and easy to make, and easy to use.

### BRIEF DESCRIPTION OF THE DRAWINGS

FIG. 1 is a front perspective view of a doorknob glove or cover for use in conjunction with a doorknob;

FIG. 2 is a side elevational view of the doorknob cover or glove shown in FIG. 1 surrounding the doorknob;

FIG. 3 is a front elevational view of an elongated cylindrical dispenser for dispensing disposable covers along with an associated waste container for disposing the used covers.

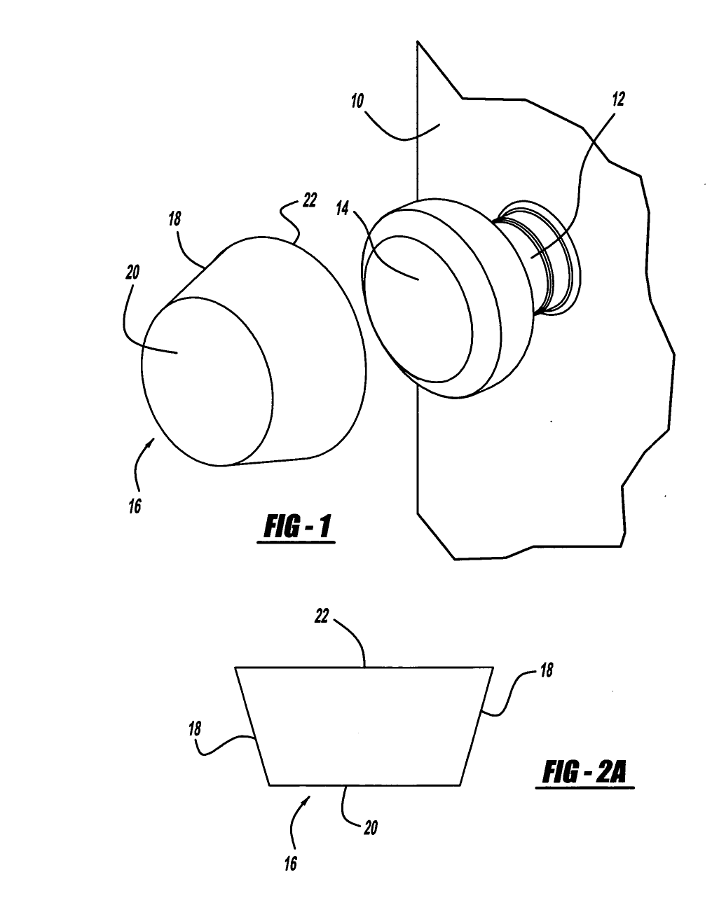

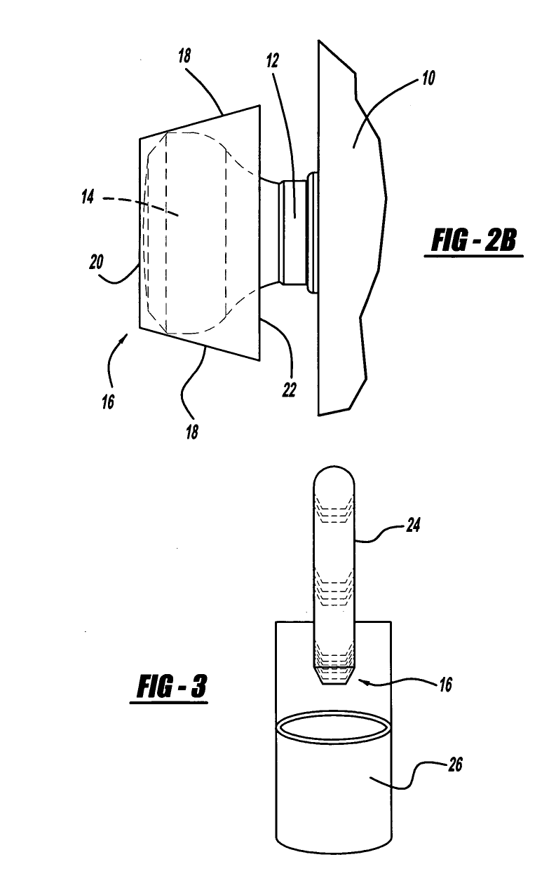

### DETAILED DESCRIPTION OF THE PREFERRED EMBODIMENT

A disposable hygienic doorknob cover or glove and the means for dispensing and disposing of same will now be delineated in detail with reference to the accompanying drawings.

As illustrated in the figures, there will now be described a disposable doorknob/handle cover or glove 16 for use with doorknobs 14 attached to a door 10. The cover 16 is a hollow three-dimensional cylindrical body, which includes a closed bottom surface 20 and an open end 22. The cover 16 resembles a cup like shape, which includes a bottom surface 20 and an outwardly tapered circumferential wall portion 18. The diameter of the bottom surface 20 is smaller than the diameter at the open end 22 of the cover 16. The diameter of the bottom surface 20 of the cover 16 is such that it is larger than the outer diameter of the doorknob 14 or alternatively corresponds approximately to the diameter of the doorknob. The doorknob cover or shield 16 is sized such that when applied over the knob it would substantially cover the doorknob 14, and a portion of the shaft 12 of the knob 14, thereby offering a complete barrier between the skin of the palm and fingers of the hand and the surface of the doorknob 14, so that no germ or unsanitary material would come in direct contact with the exposed hand surface. In addition to the doorknob cover or glove 16, there is provided an elongated cylindrical dispenser/container 24 inside which individual covers 16 are stacked for individual dispensing. The dispenser or container 24 may also be a dispenser box, which includes a dispensing slit on its top side or bottom surfaces, depending upon the orientation of the placement of the container. The instant invention also provides an accompanying wastebasket 26 so that, after using each cover or glove 16, the cover can be disposed of inside the basket 26 preventing cross-contamination of germs or bacteria. While particular embodiments of the instant invention have been presented and described, it will be obvious to those skilled in the related art that alterations to the invention may be made without departing from the spirit of this invention in its broader aspects and, therefore, the aim in the appended claims is to cover all such changes and modifications as would fall within the true spirit and scope of the instant invention.

What is claimed is:

1. A disposable hygienic doorknob cover for holding and manipulating an exposed doorknob or handle, said cover comprising:
a hollow three-dimensional cylindrical body having:
a bottom surface;
a wall portion attached to said bottom surface; and
an open end oppositely disposed from said bottom surface, whereby said hollow three-dimensional cylindrical body may be held by the hand of a user and disposed over a door handle when opening or closing said door.

2. The doorknob cover as claimed in claim 1 further comprising:
a dispenser member having a cylindrical tube shape with open ends whereby said three-dimensional cylindrical body of said doorknob cover maybe inserted into the top end thereof and frictionally maintained in said cylindrical dispenser for disposal therefrom through said other open end of said cylindrical dispenser tube; and
means for mounting said tube to an upright surface.

3. The doorknob cover as claimed in claim 1 further comprising a cylindrical waste container having a closed end and an open end opposite thereto whereby said doorknob cover maybe discarded into said open end of said waste container after use thereof on said doorknob.

4. The doorknob cover as claimed in claim 2 further comprising a cylindrical waste container having a closed end and an open end opposite thereto whereby said doorknob cover maybe discarded into said open end of said waste container after use thereof on said doorknob.

5. The doorknob cover as claimed in claim 2, wherein said covers are stacked inside said dispenser member for easy dispensing.

6. The doorknob cover as claimed in claim 2, wherein said dispenser is a box shaped container having a slit opening for easy dispensing of said disposable covers.

7. The doorknob cover as claimed in claim 1, wherein said wall portion flares outwardly from said closer end toward said open end.

8. The doorknob cover as claimed in claim 3, further comprising means for attaching said cylindrical wastebasket to said dispenser.

9. The doorknob cover as claimed in claim 3, wherein said covers are stacked inside said dispenser member for easy dispensing.

10. The doorknob cover as claimed in claim 5, wherein said wall portion flares outwardly from said closer end toward said open end.
